(19) United States
(12) Patent Application Publication
(10) Pub. No.: US 2024/0044670 A1
(43) Pub. Date: Feb. 8, 2024

(54) Laser Calibration Device and Adjustment Method Therefor

(71) Applicant: Robert Bosch GmbH, Stuttgart (DE)

(72) Inventors: Sai Kei Wong, Hong Kong (CN); Benhur Seneca, Hong Kong (CN); Ming Ho Ho, Hong Kong (CN)

(21) Appl. No.: 18/253,745

(22) PCT Filed: Nov. 24, 2020
(86) PCT No.: PCT/CN2020/131183

§ 371 Date: Oct. 20, 2023

(51) Int. Cl. G01C 25/00

(52) U.S. Cl. CPC G01C 25/00

(57) ABSTRACT

A laser calibration apparatus includes: a laser generating apparatus having: a housing; a laser generator disposed within the housing and configured to generate a calibration laser; and an auto-leveling element disposed within the housing, the auto-leveling element being connected to the laser generator and configured to drive, the laser generator to swing in multiple directions, such that the calibration laser generated by the laser generator is parallel to the horizontal plane. The laser calibration apparatus has a semi-locked state, in which swinging of the auto-leveling element in a front-and-rear direction is restricted. The laser generating apparatus is provided with sufficient leveling freedom before forward and backward swinging of the auto-leveling element is locked, and the forward and backward swinging of the auto-leveling element is locked after the leveling is completed, thereby avoiding issues such as motion dead points.

### TECHNICAL FIELD

This application relates to the field of laser calibration, and more particularly, the present application relates to a one-way locking laser calibration apparatus.

### BACKGROUND

In the prior art, applying laser technology to the field of measurement or construction to perform working tasks such as measurement, alignment, or adjustment of target objects is already a mature technique. A conventional laser calibration apparatus generally is a laser generating apparatus and an adjustment accessory. The laser generating apparatus is configured to emit different types of calibration lasers to meet the requirements of an actually-performed calibrating task, and the adjustment accessory is configured to adjust a calibration laser that is projected on an object to be calibrated. For example, for a laser generating apparatus that emits a horizontal laser line, it is usually necessary to adjust the height of the calibration laser by means of the adjustment accessory in order to improve working efficiency. For the foregoing type of laser calibration apparatus, there are two types of laser generating apparatuses. One type of laser generating apparatus is not equipped with an auto-leveling element, and thus such apparatus has a higher requirement for the flatness of an operating area and the proficiency of an operator. The other type of laser generating apparatus is equipped with an auto-leveling element. Such auto-leveling element can have the function of swinging in multiple directions to achieve leveling, and omni-directional locking can be performed after the leveling is completed, such that no further relative movement occurs between the laser generator and the auto-leveling element. At this point, if operations such as height adjustment or horizontal swinging of the emitted laser are performed, or if the laser calibration apparatus is moved a small distance, the leveling thereof may no longer be precise. However, laser generating apparatuses require high precision, so re-leveling may be required for each operation in such circumstances, which is time-consuming.

Accordingly, it is desirable to make improvements to laser calibration apparatuses to overcome the deficiencies existing in the prior art.

### SUMMARY

In view of the foregoing, the present invention provides a laser calibration apparatus, thereby effectively addressing or alleviating one or more of the above problems and other problems existing in the prior art.

To address one of the above technical problems, according to one aspect of the present application, provided is a laser calibration apparatus, comprising: a laser generating apparatus having: a housing; a laser generator disposed within the housing and configured to generate a calibration laser; an auto-leveling element disposed within the housing, the auto-leveling element being connected to the laser generator and configured to drive, under the action of the gravity of the laser generator, the laser generator to swing in multiple directions, such that the calibration laser generated by the laser generator is parallel to the horizontal plane; wherein the laser calibration apparatus has a semi-locked state, and when in the semi-locked state, swinging of the auto-leveling element in a front-and-rear direction is restricted.

To address one of the above technical problems, according to another aspect of the present application, further provided is an adjusting method for a laser calibration apparatus, which is applied to the laser calibration apparatus described above, the method comprising: S100, unlocking the locking member, and the auto-leveling element driving, under the action of the gravity of the laser generator, the laser generator to swing in multiple directions, such that the emission direction of the calibration laser of the laser generator is parallel to the horizontal plane; and S200, locking the locking member, such that swinging of the auto-leveling element and the laser generator in a front-and-rear direction is restricted.

According to the technical solutions of the present application, by means of providing for the laser generating apparatus an auto-leveling element in which only the swinging in the front-and-rear direction can be locked, debugging of the apparatus before formal working is facilitated. For example, before locking, the laser generating apparatus is provided with sufficient leveling freedom. Further, in the formal working process of the apparatus after the leveling is completed, by means of locking only the swinging in the front-and-rear direction but not in other directions, in one aspect, an undesirable large-angle tilt during movement or operation of the machine can be avoided, thus avoiding issues such as motion dead points, and in another aspect, in the formal working process of the machine, a certain degree of leveling can be achieved through swinging of the auto-leveling element in other directions when height adjustment of the emitted laser is achieved by other accessories or manual operations.

### BRIEF DESCRIPTION OF THE DRAWINGS

The present invention will be more fully understood with reference to the detailed description of preferred embodiments in conjunction with the accompanying drawings in which like reference numerals identify the same elements in the figures. In the accompanying drawings:

FIG. 1 is a perspective schematic diagram of an adjustable pedestal and a laser calibration reference device in one embodiment of a laser calibration apparatus;

FIG. 2 is a perspective schematic diagram of a universal joint connector of a laser generating apparatus in one embodiment of a laser calibration apparatus;

FIG. 3 is a perspective schematic diagram of a universal joint connector of a laser generating apparatus in one embodiment of a laser calibration apparatus, wherein a cantilever assembly is omitted;

FIG. 4 is a side schematic diagram of the universal joint connector of the laser generating apparatus in one embodiment of the laser calibration apparatus in FIG. 3, wherein a cross drive shaft is swinging forward;

FIG. 5 is a side schematic diagram of the universal joint connector of the laser generating apparatus in one embodiment of the laser calibration apparatus in FIG. 3, wherein the cross drive shaft is swinging backward;

FIG. 6 is a side schematic diagram of a laser generating apparatus in which a housing is omitted in one embodiment of a laser calibration apparatus, wherein a locking pin is not locked by a clamp member;

FIG. 7 is a side schematic diagram of a laser generating apparatus in which a housing is omitted in one embodiment of a laser calibration apparatus, wherein a locking pin is locked by a clamp member;

FIG. 8 is a perspective schematic diagram of a laser generating apparatus in one embodiment of a laser calibration apparatus, wherein a locking pin is locked by a clamp member;

FIG. 9 is a partial enlarged schematic diagram of the laser generating apparatus in one embodiment of the laser calibration apparatus in FIG. 8, wherein the locking pin is locked by the clamp member;

FIG. 10 is a perspective schematic diagram of a laser generating apparatus in one embodiment of a laser calibration apparatus, wherein a mode switch on a housing is shown;

FIG. 11 is an application schematic diagram of one embodiment of a laser calibration apparatus, wherein a laser generating apparatus and a laser calibration reference device are shown;

FIG. 12 is a schematic diagram of a laser generating apparatus in one embodiment of a laser calibration apparatus that experiences an angular deflection error when in application;

FIG. 13 is a perspective schematic diagram of a correction means after a laser generating apparatus in one embodiment of a laser calibration apparatus experiences an angular deflection error in application;

FIG. 14 is a top schematic diagram of a correction means after a laser generating apparatus in one embodiment of a laser calibration apparatus experiences an angular deflection error in application; and

FIG. 15 is a flow diagram of one embodiment of an adjusting method for a laser calibration apparatus.

### DETAILED DESCRIPTION

The present application will be described in detail below with reference to exemplary embodiments in the accompanying drawings. However, it is to be appreciated that the present application may be implemented in many different forms, and should not be construed as limited to the embodiments set forth herein. These embodiments are provided herein to make the disclosure of the present application more complete and near, and fully convey the concept of the present application to those skilled in the art.

Further, for any single technical feature described or implied in the embodiments mentioned herein, or any single technical feature shown or implied in the accompanying drawings, the present application still allows for any combination or deletion among these technical features (or equivalents thereof) without encountering any technical obstacles, thereby obtaining a greater number of other embodiments of the present application that may not be mentioned directly herein.

Herein, for ease of description of the structure or relative positional relationships of individual components, a coordinate system for describing the directions is provided. For example, a longitudinal axis X that is directed in the front-and-rear direction, a transverse axis Y that is directed in the left-and-right direction, and a vertical axis Z that is directed in the up-and-down direction. The above directional coordinate system is established by using a laser emission direction of the laser generator as the “front” described herein. It is to be appreciated that the establishment of the coordinate system is intended to simplify the textual description of embodiments of the laser calibration apparatus of the present application, rather than constituting a mandatory limitation on the directions. Those skilled in the art could arbitrarily adjust the directional coordinate system according to needs or habits, and the adjustment should still fall within the scope of the claims listed in the present application as long as it is consistent with the concept of the present application.

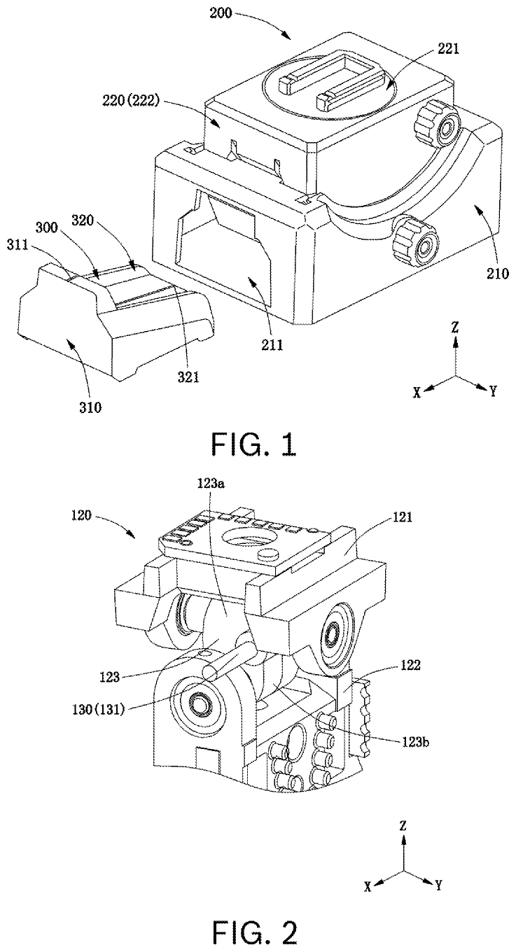

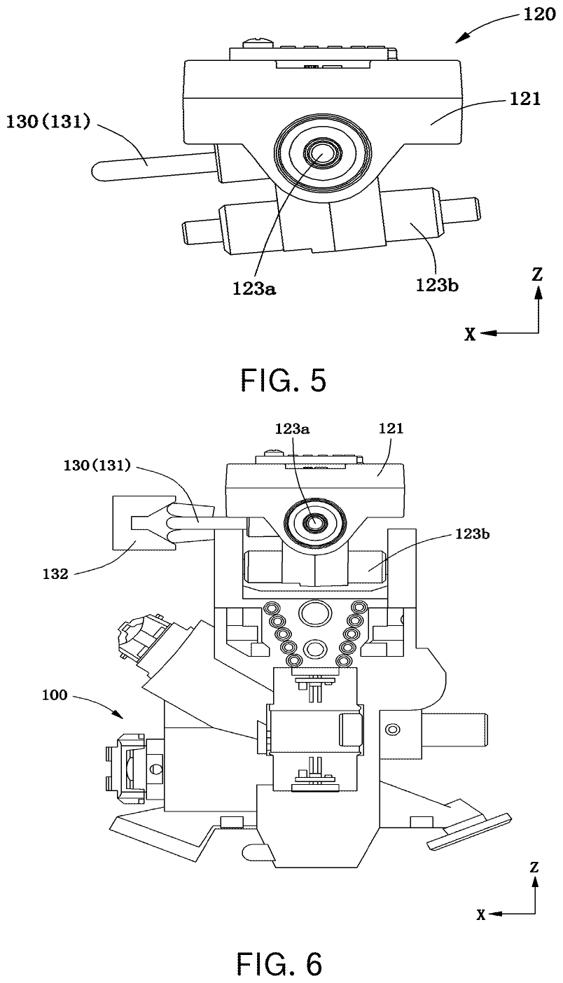

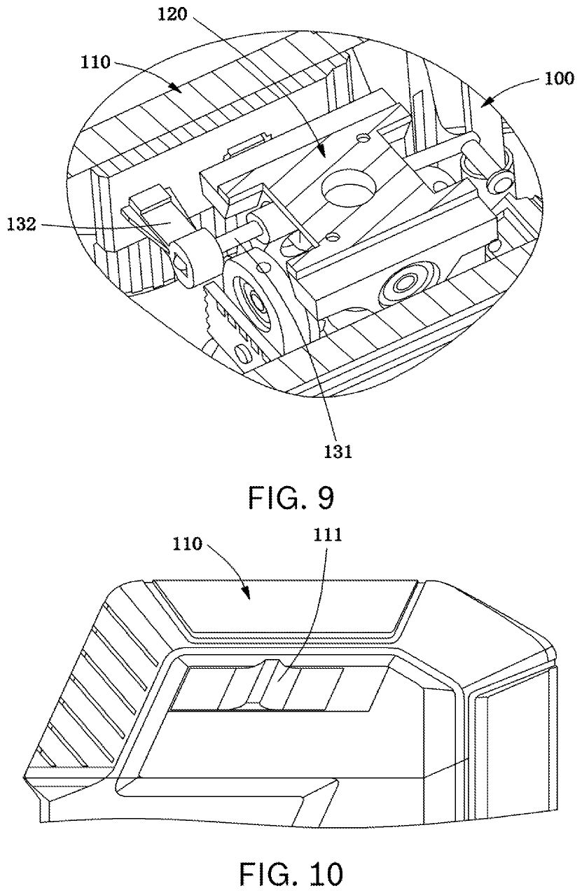

With reference to FIGS. 1-11 in combination, embodiments of a laser calibration apparatus are provided. The laser calibration apparatus generally includes two parts, i.e.: a laser generating apparatus 100 as shown in FIGS. 2 and 6-9 and an adjustable pedestal 200 as shown in FIG. 1. The laser generating apparatus 100 is configured to provide a calibration laser, and includes a housing 110 and a laser generator that is disposed within the housing 110 and is not shown in the figures. The adjustable pedestal 200 is configured to make further adjustments to the laser projected by the laser generating apparatus 100 on a target to be calibrated, for example, changing the height thereof or translating the same, etc. The adjustable pedestal 200 includes a base 210 and an adjustable platform 220. The adjustable platform 220, in one aspect, may be connected to the laser generating apparatus 100 by means of fixing means such as fastening or screwing, so as to achieve the linkage between the two, and in another aspect, may be movably connected to the base 210, so as to swing forward and backward with respect to the transverse axis Y of the base 210, such that adjustment of the height of the emitted calibration laser is achieved by driving the laser generating apparatus 100 to swing forward and backward, or so as to swing left and right with respect to the vertical axis Z of the base 210, such that emitting the transverse position of the calibration laser is achieved by driving the laser generating apparatus 100 to swing left and right. In the foregoing arrangement, the technical solutions of the present application achieve adjustment of the swinging of the laser generating apparatus by providing the laser generating apparatus with an adjustable platform. As a result, in one aspect, calibration in the horizontal direction of the laser generating apparatus can be achieved, and in another aspect, proportional adjustment in the vertical direction of the calibration laser projected by the laser generating apparatus on an object to be calibrated can be achieved. The foregoing configuration can provide a larger adjustment range, and for example, the adjustment range can be easily increased by rotating the laser generating apparatus and increasing the distance between the laser generating apparatus and the object to be calibrated. Further, the laser calibration apparatus can have a semi-locked state, and when in the semi-locked state, swinging of the auto-leveling element in the front-and-rear direction is restricted. In this case, by means of providing for the laser generating apparatus an auto-leveling element in which only the swinging in the front-and-rear direction can be locked, debugging of the apparatus before formal working is facilitated, and for example, before locking, the laser generating apparatus is provided with sufficient leveling freedom. Further, in the formal working process of the apparatus after the leveling is completed, by means of locking only the swinging in the front-and-rear direction but not in other directions, in one aspect, an undesirable large-angle tilt during movement or operation of the machine can be avoided, thus avoiding issues such as motion dead points, and in another aspect, during the formal working process of the machine, a certain degree of leveling can be achieved through swinging of the auto-leveling element in other directions when height adjustment of the emitted laser is achieved by other accessories or manual operations.

On the basis of the foregoing embodiments, several modifications can also be made to the various components of the laser calibration apparatus or connection positional relationships thereof to achieve other technical effects, which will be exemplified in the following.

For example, with reference to FIGS. 2-9, the laser generating apparatus 100 may further include an auto-leveling element disposed within the housing 110 so as to facilitate the automatic leveling of the calibration laser that is generated by the laser generator. In particular, the auto-leveling element may be connected to the laser generator. In this case, when the laser generating apparatus 100 is tilted due to changes in the application scenario, the auto-leveling element will move under the action of the gravity of the laser generator itself and meanwhile, drive the laser generator to swing in multiple directions for auto-leveling, such that the calibration laser that is generated by the laser generator is parallel to the horizontal plane. The laser generating apparatus 100 may further include a locking member 130. For ease of performing the laser calibration function, after the auto-leveling of the laser generating apparatus 100 is completed, only the swinging of the auto-leveling element in the front-and-rear direction may be restricted by the locking member 130. It should be appreciated by those skilled in the art that although the restricted swinging is in the front-and-rear direction, the direction is not limited to straight ahead or straight behind. In accordance with the teachings of the present invention, as long as the swinging has a component in the front-and-rear direction and the limitations to the swinging can achieve the purposes of the present invention, such directions all belong to the “front-and-rear direction” that the present application is intended to describe.

With continued reference to FIGS. 2 and 6-7, specific embodiments of an auto-leveling element, i.e., a universal joint connector 120, are shown. The universal joint connector 120 includes a universal joint base 121 that is connected to the housing 110, a cantilever assembly 122 that is connected to the laser generator, and a cross drive shaft 123 that is pivotally connected between the universal joint base 121 and the cantilever assembly 122. The cantilever assembly 122 and the universal joint base 121 function as connecting components, and the cross drive shaft 123 disposed therebetween functions as a drive component.

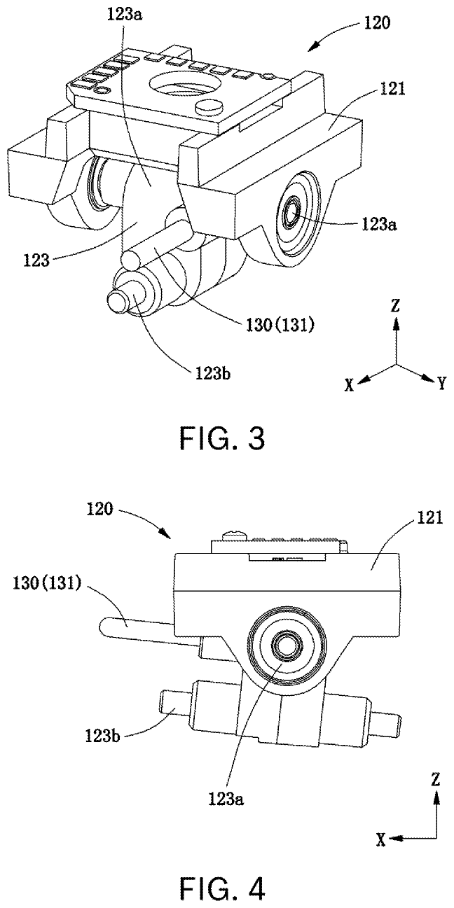

To illustrate the structure of the cross drive shaft 123 more clearly, FIGS. 3-5 show the universal joint connector 120 in which the cantilever assembly 122 is omitted. As can be seen in the figures, the cross drive shaft 123 includes a first drive shaft 123a that extends along a transverse axis Y of the universal joint connector 120 and a second drive shaft 123b that extends along a longitudinal axis X of the universal joint connector 120. The first drive shaft 123a is pivotally connected to the universal joint base 121, and the second drive shaft 123b is pivotally connected to the cantilever assembly 122. In the foregoing arrangement, the universal joint base 121 and the components connected thereto can swing forward and backward with respect to the first drive shaft 123a, and the cantilever assembly 122 and the components connected thereto can swing left and right with respect to the second drive shaft 123b.

In particular, because the universal joint base 121 is fixed to the housing 110 of the laser generating apparatus 100, no further relative movement is allowed. Thus, the relative movement, whether the same is swinging forward and backward or swinging left and right, is performed with respect to the laser generator to which the cantilever assembly 122 is connected. In this case, because the laser generator is rotatably suspended below the universal joint connector 120, when there is a circumstance where the entire apparatus is tilted, under the action of gravity, the first drive shaft 123a of the cross drive shaft 123 can drive the laser generator to swing forward and backward with respect to the transverse axis Y of the universal joint connector 120, or the second drive shaft 123b of the cross drive shaft 123 can drive the laser generator to swing left and right with respect to the longitudinal axis X of the universal joint connector 120, such that the calibration laser generated by the laser generator is parallel to the horizontal plane.

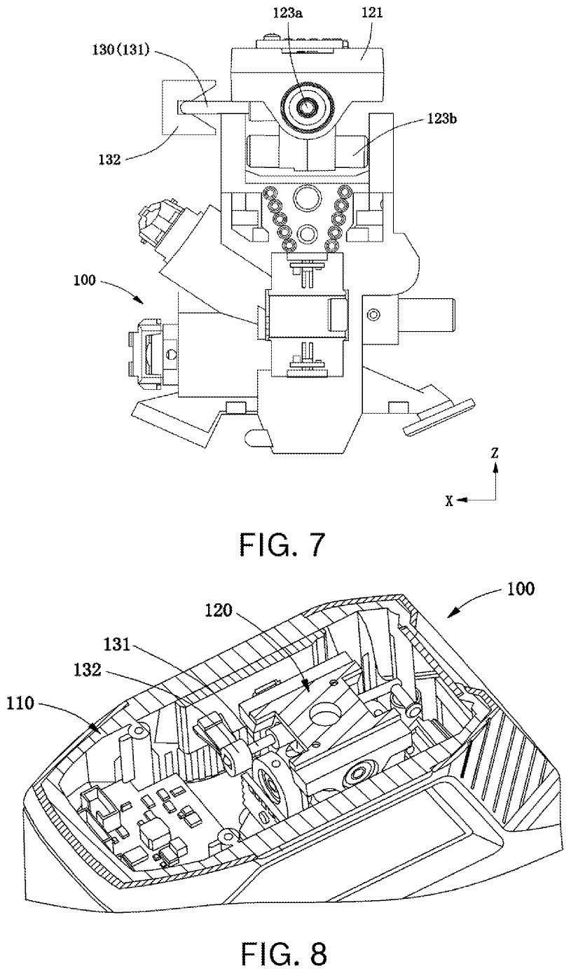

With continued reference to FIGS. 6-9, an embodiment of a locking member is shown. The locking member 130 is specifically configured to restrict only the swinging of the universal joint connector 120 in the front-and-rear direction (i.e., the direction indicated by the transverse axis Y shown in the figures). In particular, the locking member 130 includes a clamp member 132 that is disposed within the housing 110 and a corresponding locking pin 131 that is disposed on the universal joint connector 120. As shown in FIG. 6, the locking pin 131 and the clamp member 132 are in a disengaged state. In this case, the swinging direction of the universal joint connector 120 is only affected by gravity without constraints, so as to allow auto-leveling. As shown in FIGS. 7-9, after the auto-leveling is completed, the clamp member 132 can be actuated by an actuator to lock the locking pin 131. In this case, the locking member 130 can restrict forward and backward swinging of the universal joint connector 120 (i.e., the direction indicated by the transverse axis Y shown in the figures) by locking only the first drive shaft 123a, that is to say, the angle between the emitted laser and a wall will be fixed, such that height adjustment of the emitted laser during the actual calibration process is subsequently achieved by means of the adjustable pedestal 200. If, during the laser height adjustment by the adjustable pedestal 200 by means of rotation of the laser generator, slight shaking of the laser generating apparatus occurs, the leveling can still be achieved by means of the swinging of the unlocked universal joint connector 120 in the left-and-right direction (i.e., the direction indicated by the longitudinal axis X shown in the figures).

In another aspect, for the adjustable pedestal, further improvements may also be made to the adjustable platform therein. For example, referring to FIG. 1, the adjustable platform 220 is configured to include a rotating platform 221 and a swinging platform 222, which may be configured to perform respective actions, respectively. In particular, the rotating platform 221 may be connected to the laser generating apparatus 100 and can drive the laser generating apparatus 100 to swing left and right with respect to the vertical axis Z of the base 210. The swinging platform 222 is connected to the rotating platform 221 and can drive the laser generating apparatus 100 and the rotating platform 221 to swing forward and backward with respect to the transverse axis Y of the base 210. As shown, to achieve the assembly of the rotating platform and the swinging platform and avoid the interference in movement therebetween, a circular opening may be provided at a top portion of the swinging platform 222, and the rotating platform 221 may be configured as a circular platform, such that the circular rotating platform 221 may be disposed in the circular opening of the swinging platform 222. The circular profile fit therebetween is such that the left and right swinging of the rotating platform 21 with respect to the vertical axis Z of the base 210 is not interfered with by the swinging platform 222 and can drive the laser generating apparatus 100 connected thereto to swing left and right, so as to achieve adjustment of the transverse position of the laser that is projected on the object to be calibrated, and such that forward and backward swinging of the swinging platform 222 with respect to the transverse axis Y of the base 210 can drive the rotating platform 221 and the laser generating apparatus 100 connected thereto to swing forward and backward together, so as to achieve adjustment of the height of the laser that is projected on the object to be calibrated.

Furthermore, for ease of operation, knobs and associated drive mechanisms may be respectively provided on the adjustable pedestal 200 to achieve control of the rotating platform 221 and the swinging platform 222 on the adjustable platform 220. As an example, a control knob of the rotating platform 221 may be disposed on the adjustable platform 220, and a control knob of the swinging platform 222 may be disposed on the base 210.

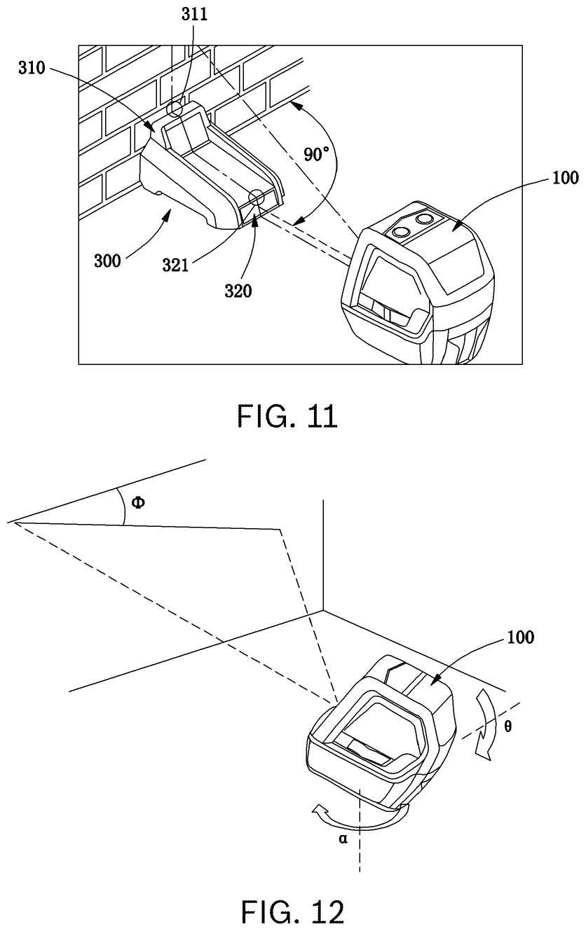

In addition, to further improve the convenience of the laser calibration apparatus during alignment with (i.e., perpendicular to) the object to be calibrated, the laser calibration apparatus may be provided with an additional laser calibration reference device 300. As shown in FIGS. 1 and 11, the laser calibration reference device has a vertical rear wall 310 that abuts against the object to be calibrated and a front wall 320 that faces the laser generating apparatus 100. The rear wall 310 is provided with a calibration mark 311 and the front wall 320 is provided with a calibration mark 321, and a line connecting the two calibration marks is perpendicular to the rear wall. With the aid of the laser calibration reference device, the laser generating apparatus 100 is driven to swing left and right with respect to the vertical axis Z of the base 210 by means of operating the rotating platform 221, such that the calibration laser emitted by the laser generator overlaps with the line connecting the calibration marks 311 and 321. Thus, alignment of the laser generator with the object to be calibrated can be achieved quickly and conveniently, so as to perform the subsequent calibration process.

Optionally, although the laser calibration apparatus and the laser calibration reference device are presented as separate structures when in application, in a non-application state, both may be assembled together for ease of carrying. For example, as shown in FIG. 1, the base 210 of the adjustable pedestal 200 may be provided with an accommodating space 211 having an opening, configured to accommodate the laser calibration reference device 300 that is in a non-application state.

Further, although the laser calibration apparatus in the foregoing embodiments may be applied to various laser calibration scenarios, the same is particularly suitable for occasions in which a linear laser is needed for calibration. In this case, the linear laser can be leveled quickly and accurately by means of the horizontal swinging function of the laser calibration apparatus. Additionally, the height of the linear laser can be conveniently adjusted through the front-and-rear swinging function of the laser calibration apparatus. Thus, the laser generated by the laser generator may further be converted into a linear laser or a cross laser via a diffraction channel.

With reference to the laser calibration apparatus in the previous embodiments, the present application provides three operating modes for the laser calibration apparatus by means of disposing a switch 111 on the housing 110 and touch-activating the switch: an on mode, an off mode, and a semi-locked mode. In the on mode, the laser generator starts working and can generate the calibration laser, and meanwhile, the swinging direction of the universal joint connector 120 for auto-leveling will change along with gravity, and the swinging thereof will not be otherwise limited. In the off mode, the laser generator stops generating the calibration laser, and meanwhile, the universal joint connector 120 for auto-leveling will be completely locked and can no longer swing in any direction. In the semi-locked mode, the laser generator works normally, and meanwhile, as mentioned in the foregoing embodiments, the clamp member 132 will lock the locking pin 131, and in this case, the universal joint connector 120 and the laser generator connected thereto can only swing in the left-and-right direction (i.e., the direction indicated by the longitudinal axis X shown in the figures), and can no longer swing in the front-and-rear direction. The foregoing mode is generally suitable for the situation in which vertical alignment between the laser generating apparatus and the object to be calibrated (e.g., a wall face) has been completed. In this case, further vertical adjustment is usually not required, and the forward and backward swinging of the universal joint connector 120 may be locked, that is to say, early-stage debugging of the laser calibration has been completed. Subsequently, vertical or transverse translation of the laser emitted by the laser generator (the debugging process of transverse translation generally requires the assistance of the laser calibration reference device) may be achieved by the adjustable pedestal (200), so as to achieve adjustment of the height or position of the laser on the wall face.

As shown in FIG. 12, during the application of the foregoing type of laser calibration apparatus in the semi-locked mode, when the laser generating apparatus projects a horizontal line laser, an error of the laser projection angle between the laser generating apparatus and the object to be calibrated may be caused due to factors such as site or operation. The angular error cp of the horizontal line laser is affected by parameters such as the forward and backward swinging angle θ of the laser generating apparatus, the angle α of the projected calibration laser, the shortest distance dv between the laser generating apparatus and the target to be calibrated, and the width wt of the calibration mark on the laser calibration reference device 300.

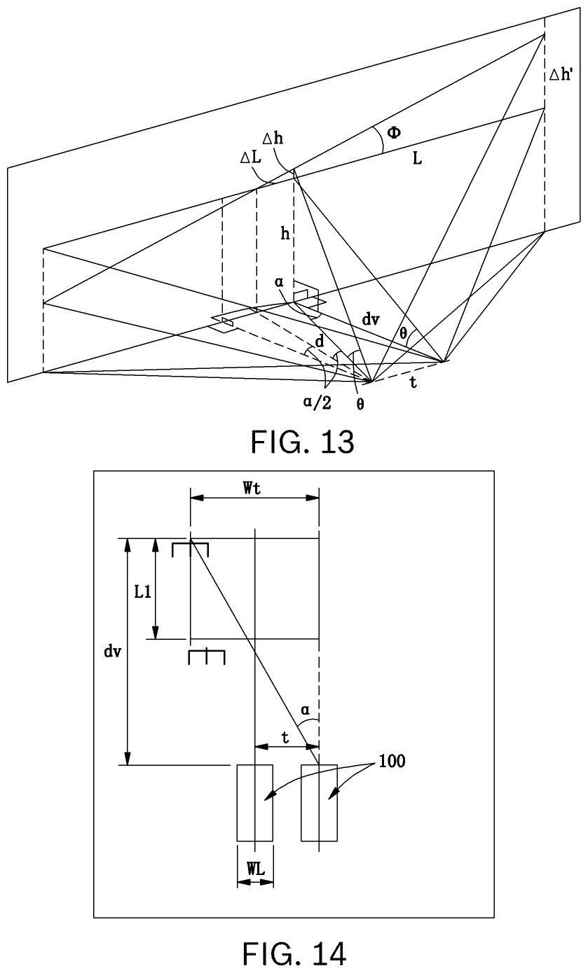

With continued reference to FIGS. 13 and 14, by combining various parameters shown in the drawings and the following calculation formulas characterizing parameter relationships, the angular error φ of the horizontal line laser may be finally obtained by calculation:

d=dv/cos α, (1):

tan θ=(h+Δh)/d, (2):

h=dv*tan θ, (3):
by combining equations (1)-(3), Δh=dv*tan θ/cos α−h is derived;

ΔL=t−dv*tan(α/2), (4):

t=wt/2, (5):

φ=atan(ΔL/Δh) (6):
by combining equations (4)-(6), φ=atan(t−dv*tan(α/2))/(dv*tan θ(1/cos α−1)) is derived.

Thus, even if there is a slight angular error φ of the horizontal line laser during operation, the angular error φ may be derived by the acquisition and calculation of the aforementioned known parameters for ease of correction. In this way, it will be more convenient for the user to operate the apparatus.

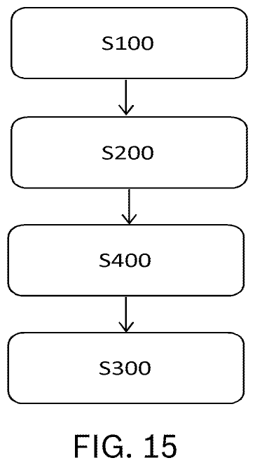

An adjusting method suitable for the laser calibration apparatus in any of the foregoing embodiments or combinations thereof will be further described below in connection with FIG. 15.

The method may generally include a leveling step and a debugging step.

With regard to the leveling step, the same is intended to achieve, before the laser calibration apparatus works formally, auto-leveling of the laser generating apparatus relative to an application environment. For example, when there is a small angle of slope in the application environment, S100 may be performed, wherein the locking member 130 is unlocked. In this case, the auto-leveling element drives, under the action of the gravity of the laser generator, the laser generator to swing in multiple directions, such that the emission direction of the calibration laser of the laser generator is parallel to the horizontal plane. S200 is then performed, wherein the locking member 130 is locked. In this case, the swinging of the auto-leveling element and the laser generator in the front-and-rear direction is restricted, and the auto-leveling element can still drive, under the action of the gravity of the laser generator, the laser generator to swing in other directions, thereby completing the auto-leveling before the apparatus works.

Thereafter, with regard to the debugging step, the same is intended to achieve the debugging of the emitted laser of the laser generating apparatus relative to the object to be calibrated according to the calibration requirements during the working process of the laser calibration apparatus. For example, to debug the height of the calibration laser, S300 may be performed, wherein the adjustable platform 220 of the adjustable pedestal 200 is adjusted, such that the adjustable platform 220 and the laser generating apparatus 100 that is connected thereto swing forward and backward with respect to the transverse axis Y of the base 210, so as to adjust the height of the emitted calibration laser. As another example, to adjust the perpendicularity of the calibration laser to the object to be calibrated (e.g., a wall), S400 may be performed, wherein the adjustable platform 220 of the adjustable pedestal 200 is adjusted, such that the adjustable platform 220 and the laser generating apparatus 100 that is connected thereto swing left and right with respect to the vertical axis Z of the base 210, so as to adjust the emitted calibration laser to overlap with a line connecting the calibration marks 311 and 321, thereby achieving the debugging of the perpendicularity to the wall. It is to be appreciated that although the swinging of the auto-leveling element and the laser generator in the front-and-rear direction thereof has been locked, when the height adjustment or perpendicularity adjustment of the emitted laser is achieved by other accessories and manual operations during the debugging process for formal working of the machine, a certain degree of leveling can be still achieved by means of the swinging of the unlocked auto-leveling element in other directions.

The above specific embodiments are only used for illustrating the present application, and are not limitations of the present application. To illustrate relative positional relationships, relative orientation terms such as left and right, up and down, etc., are used in the present application, but are not definitions of absolute positions. Those of ordinary skill in the art could further make various changes and variations to the technical solutions of the present application without departing from the scope of the present application, and thus all equivalent technical solutions are also within the scope of the present application, and the patent protection scope of the present application should be defined by the claims.

1. A laser calibration apparatus, comprising:
a laser generating apparatus having:
a housing;
a laser generator disposed within the housing and configured to generate a calibration laser; and
an auto-leveling element disposed within the housing the auto-leveling element being connected to the laser generator and configured to drive, under the action of gravity of the laser generator, the laser generator to swing in multiple directions such that an emission direction of the calibration laser of the laser generator is parallel to the horizontal plane,
wherein the laser calibration apparatus has a semi-locked state in which swinging of the auto-leveling element in a front-and-rear direction is restricted.

2. The laser calibration apparatus according to claim 1, wherein the auto-leveling element comprises:
a universal joint connector, configured to (i) drive, under the action of gravity, the laser generator to swing forward and backward with respect to a transverse axis of the universal joint connector, and/or (ii) drive the laser generator to swing left and right with respect to a longitudinal axis of the universal joint connector, such that the calibration laser generated by the laser generator is parallel to the horizontal plane; and
a locking member configured to restrict only forward and backward swinging of the universal joint connector.

3. The laser calibration apparatus according to claim 2, wherein:
the locking member comprises:
a locking pin; and
a corresponding clamp member;
one of the locking pin and the clamp member is disposed within the housing and the other of the locking pin and the clamp member is disposed on the universal joint connector; and
when the locking pin is locked by the clamp member, the locking member restricts only forward and backward swinging of the universal joint connector.

4. The laser calibration apparatus according to claim 2, wherein the universal joint connector comprises:
a universal joint base connected to the housing;
a cantilever assembly connected to the laser generator; and
a cross drive shaft pivotally connected between the universal joint base and the cantilever assembly, the cross drive shaft including a first drive shaft extending along the transverse axis of the universal joint connector and a second drive shaft extending along the longitudinal axis of the universal joint connector.

5. The laser calibration apparatus according to claim 4, wherein the first drive shaft is pivotally connected to the universal joint base and the second drive shaft is pivotally connected to the cantilever assembly.

6. The laser calibration apparatus according to claim 4, wherein the locking member is configured to restrict only rotation of the first drive shaft.

7. The laser calibration apparatus according to claim 1, further comprising:
an adjustable pedestal, having:
a base; and
an adjustable platform, connected to the laser generating apparatus and the base and configured to swing forward and backward with respect to a transverse axis (Y) of the base and to swing left and right with respect to a vertical axis (Z) of the base.

8. The laser calibration apparatus according to claim 7, further comprising:
a laser calibration reference device, having a vertical rear wall abutting against an object to be calibrated and a front wall facing the laser generating apparatus,
wherein the rear wall and the front wall calibration marks, respectively, and a line connecting the calibration marks is perpendicular to the rear wall.

9. The laser calibration apparatus according to claim 8, wherein the base comprises an accommodating space having an opening, the accommodating space being configured to accommodate the laser calibration reference device.

10. The laser calibration apparatus according to claim 7, wherein the adjustable platform comprises:
a rotating platform connected to the laser generating apparatus and configured to drive the laser generating apparatus to swing left and right with respect to the vertical axis of the base; and
a swinging platform connected to the rotating platform and configured to drive the laser generating apparatus and the rotating platform to swing forward and backward with respect to the transverse axis (Y) of the base.

11. The laser calibration apparatus according to claim 10, wherein:
a top portion of the swinging platform includes a circular opening,
the rotating platform is configured as a circular platform, and
the circular platform is disposed in the circular opening of the swinging platform.

12. The laser calibration apparatus according to claim 2, wherein the apparatus is configured with:
an on mode in which the laser generator starts generating the calibration laser and the laser generator free to swing forward and backward with respect to the transverse axis of the universal joint connector, and to swing left and right with respect to the longitudinal axis of the universal joint connector;
an off mode in which the laser generator stops generating the calibration laser and both the forward and backward swinging and the left and right swinging of the laser generator are locked; and
a semi-locked mode in which the laser generator starts generating the calibration laser, forward and backward swinging of the laser generator with respect to the transverse axis of the universal joint connector is locked, and the laser generator is free to swing left and right with respect to the longitudinal axis of the universal joint connector.

13. An adjusting method for a laser calibration apparatus including a laser generating apparatus having (i) a housing, (ii) a laser generator disposed within the housing and configured to generate a calibration laser, and (iii) an auto-leveling element disposed within the housing, the auto-leveling element being connected to the laser generator and configured to drive, under the action of gravity of the laser generator, the laser generator to swing in multiple directions such that an emission direction of the calibration laser of the laser generator is parallel to the horizontal plane, the laser calibration apparatus having a semi-locked state in which swinging of the auto-leveling element in a front-and-rear direction is restricted, the auto-leveling element including (i) a universal joint connector configured to (a) drive, under the action of gravity, the laser generator to swing forward and backward with respect to a transverse axis of the universal joint connector, and/or (b) drive the laser generator to swing left and right with respect to a longitudinal axis of the universal joint connector, such that the calibration laser generated by the laser generator is parallel to the horizontal plane, the method comprising:
unlocking the locking member such that the auto-leveling element driving, under the action of the gravity of the laser generator, the laser generator to swing in multiple directions, such that the emission direction of the calibration laser of the laser generator is parallel to the horizontal plane; and
locking the locking member such that swinging of the auto-leveling element and the laser generator in a front-and-rear direction is restricted, and the auto-leveling element drives, under the action of the gravity of the laser generator, the laser generator to swing in other directions.

14. The adjusting method for a laser calibration apparatus according to claim 13, further:
adjusting an adjustable platform of an adjustable pedestal of the laser calibration apparatus such that the adjustable platform and the laser generating apparatus connected thereto swing forward and backward with respect to the transverse axis of the base so as to adjust the height of the emitted calibration laser.

15. The adjusting method for a laser calibration apparatus according to claim 14, further comprising:
adjusting the adjustable platform of the adjustable pedestal such that the adjustable platform and the laser generating apparatus connected thereto swing left and right with respect to the vertical axis of the base so as to adjust the emitted calibration laser, such that the emitted calibration laser overlaps with a line connecting calibration marks of a laser calibration reference device of the laser calibration apparatus.
